(19) United States
(12) Patent Application Publication
(10) Pub. No.: US 2022/0288883 A1
(43) Pub. Date: Sep. 15, 2022

(54) COMPACT DUNNAGE CONVERSION MACHINE

(71) Applicant: Ranpak Corp., Concord Township, OH (US)

(72) Inventor: Brian Stinard, Twinsburg, OH (US)

(21) Appl. No.: 17/594,640

(22) PCT Filed: Mar. 25, 2020
(86) PCT No.: PCT/US2020/024605

§ 371 Date: Oct. 25, 2021

Related U.S. Application Data
(60) Provisional application No. 62/838,861, filed on Apr. 25, 2019.

(51) Int. Cl. B31D 5/00

(52) U.S. Cl. CPC B31D 5/0043; B31D 2205/0047; B31D 2205/0082; B31D 2205/0035

(57) ABSTRACT

A dunnage conversion machine is provided for converting a sheet stock material into a relatively lower density dunnage product as it moves downstream through the conversion machine. The conversion machine includes a forming assembly configured to inwardly gather sheet stock material, and a feeding assembly downstream of the forming assembly. The forming assembly includes a converging chute with an inlet and a relatively smaller outlet downstream of the inlet, the converging chute being aligned along a converging axis. The feeding assembly has a pair of rotatable members rotatable about respective parallel axes of rotation. The rotatable members are arranged to feed sheet stock material from the forming assembly downstream of the feeding assembly, the rotating members defining a feed axis perpendicular to a line connecting and perpendicular to the axes of rotation. The conversion machine is characterized by the converging axis being transverse rather than aligned with the feed axis.

### FIELD OF THE INVENTION

The present invention relates to dunnage conversion machines, and more particularly to machines and methods for converting a sheet stock material into a relatively less dense dunnage product in a compact space.

### BACKGROUND

Various types of conversion machines have been used to convert sheet stock material into a dunnage product. Some machines produce a void-fill dunnage product, used primarily to fill voids in a packaging container to prevent the contents from shifting during shipment.

One objective in the design of these machines is to produce the void-fill dunnage product very rapidly. Accordingly, these machines are designed to operate at relatively high speeds.

Other than speed, some conversion machines are designed to provide a minimal machine footprint for operating in space-constrained packaging facilities or packaging areas of packaging facilities. Due to the concern for saving space, these machines often use relatively narrower sheet stock material for conversion into a dunnage product. Such a dunnage product may take twice as long to fill a container as compared to a dunnage conversion machine having both a relatively larger footprint and the ability to use a wider sheet stock material.

### SUMMARY

While many dunnage conversion machines produce an adequate dunnage product, existing dunnage conversion machines and dunnage products might not be ideal for all applications. The present invention provides a dunnage conversion machine that can operate in a relatively smaller volume than prior dunnage conversion machines, particularly within a reduced height dimension.

Accordingly, an exemplary dunnage conversion machine may be provided for converting a sheet stock material into a relatively lower density dunnage product as the sheet stock material moves downstream through the dunnage conversion machine. The dunnage conversion machine includes a forming assembly configured to inwardly gather sheet stock material, and a feeding assembly downstream of the forming assembly. The forming assembly includes a converging chute with an inlet and a relatively smaller outlet downstream of the inlet, the converging chute being aligned along a converging axis. The feeding assembly has a pair of rotatable members rotatable about respective parallel axes of rotation. The rotatable members are arranged to feed sheet stock material from the forming assembly downstream of the feeding assembly, the rotating members defining a feed axis perpendicular to a line connecting and perpendicular to the axes of rotation. The dunnage conversion machine is characterized by the converging axis being transverse rather than aligned with the feed axis.

The conversion machine may have an exemplary internal angle between the feed axis and the converging axis of between 20 degrees and 90 degrees; between 30 degrees and 70 degrees; between 40 degrees and 60 degrees; or 45 degrees, for example. The internal angle may be fixed.

The feeding assembly may include guides that bound a path of the sheet stock material from the forming assembly to a position downstream of the rotatable members. The rotatable members may extend beyond the guides to engage sheet stock material between the rotatable members. The guides may converge from a relatively large upstream opening adjacent the outlet of the converging chute to a narrower opening adjacent the rotatable members.

The rotatable members may include friction wheels.

The converging chute has a top side, opposite the internal angle between the converging axis and the feed axis, the converging chute has a round cross-section, and the top side of the converging chute may be truncated to less than a fully round shape. The converging chute converges in a downstream direction.

An exemplary dunnage conversion system includes a dunnage conversion machine as described herein and a supply of sheet stock material upstream of the forming assembly that is arranged to supply sheet stock material to the forming assembly.

The foregoing and other features of the invention are hereinafter fully described and particularly pointed out in the claims, the following description and the annexed drawings setting forth in detail one or more illustrative embodiments of the invention. These embodiments, however, are but a few of the various ways in which the principles of the invention can be employed. Other objects, advantages and features of the invention will become apparent from the following detailed description of the invention when considered in conjunction with the drawings.

### BRIEF DESCRIPTION OF THE DRAWINGS

FIG. 1 is a schematic elevation view of a dunnage conversion machine provided in accordance with the present invention.

FIG. 2 is a schematic plan view of the dunnage conversion machine of FIG. 1.

FIG. 3 is a plan view of a dunnage conversion machine as shown in FIG. 2, with a portion of a housing removed to show internal components.

FIG. 4 is a perspective view of an upstream portion of the dunnage conversion machine of FIG. 3.

FIG. 5 is a perspective elevation view of a dunnage conversion machine.

FIG. 6 is a perspective view of an upstream portion of the dunnage conversion machine of FIG. 5 with a portion of a housing removed to show internal components.

FIG. 7 is a perspective view of a portion of a packaging workstation that includes the dunnage conversion machine of FIG. 3 in an operating position. An upper obstruction is omitted in this view for clarity.

FIG. 8 is a side elevation view of a portion of the packaging workstation shown in FIG. 7.

FIG. 9 is a perspective view of a portion of a packaging workstation that includes the dunnage conversion machine of FIG. 3 in a loading position. An upper obstruction is omitted in this view for clarity.

FIG. 10 is a side elevation view of a portion of the packaging workstation shown in FIG. 9.

### DETAILED DESCRIPTION

Referring now to the drawings in detail, the present invention provides a dunnage conversion machine 10 that converts a sheet stock material 12, such as paper, into a relatively less dense dunnage product. The dunnage conversion machine 10 accomplishes this task in a compact volume, and more particularly, within a reduced height dimension H.

The dunnage conversion machine 10, also referred to as simply a conversion machine or a converter, includes a conversion assembly 14 that functions to convert the sheet stock material 12 into a dunnage product that is less dense than the supply of stock material. The sheet stock material 12, alternatively referred to as a sheet material or a stock material, is fed into the conversion assembly 14 from a supply 16 or stock supply assembly provided at an upstream end 12 of the converter 10. And the converted stock material exits the converter 10 at a downstream end 22 as a strip of dunnage or as a discrete dunnage product separated from the strip of dunnage. Accordingly, the terms “upstream” and “downstream” refer to directions along the path of the stock material 12 as it moves through the converter 10, in a downstream direction 24 from the upstream end 20 to the downstream end 22. An upstream direction is a direction toward the upstream end 20, opposite the downstream direction 24.

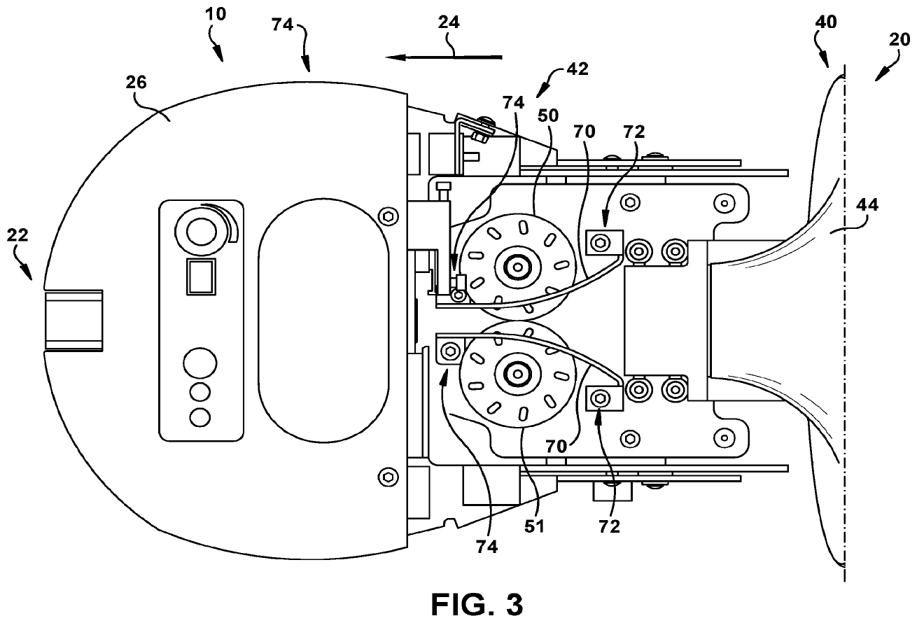

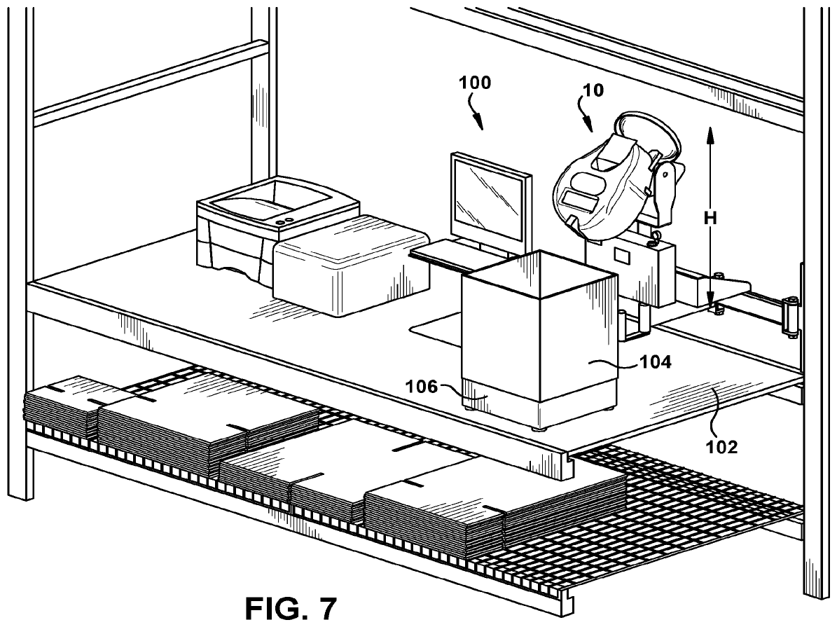

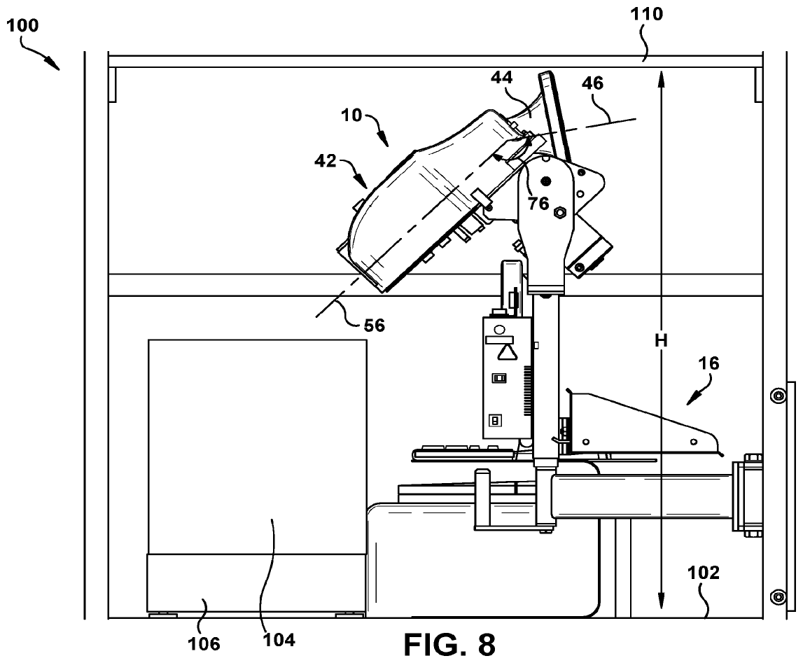

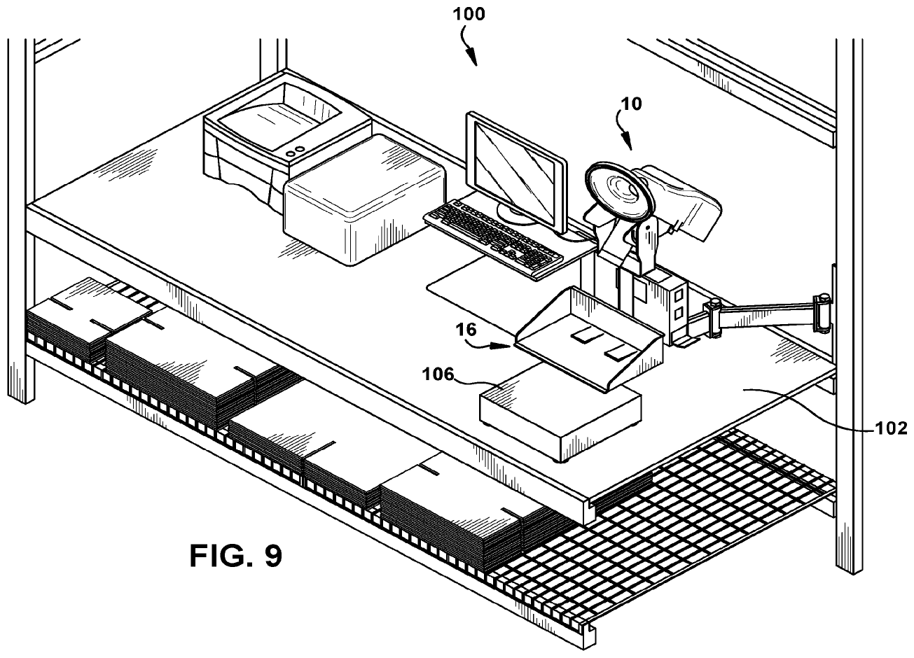

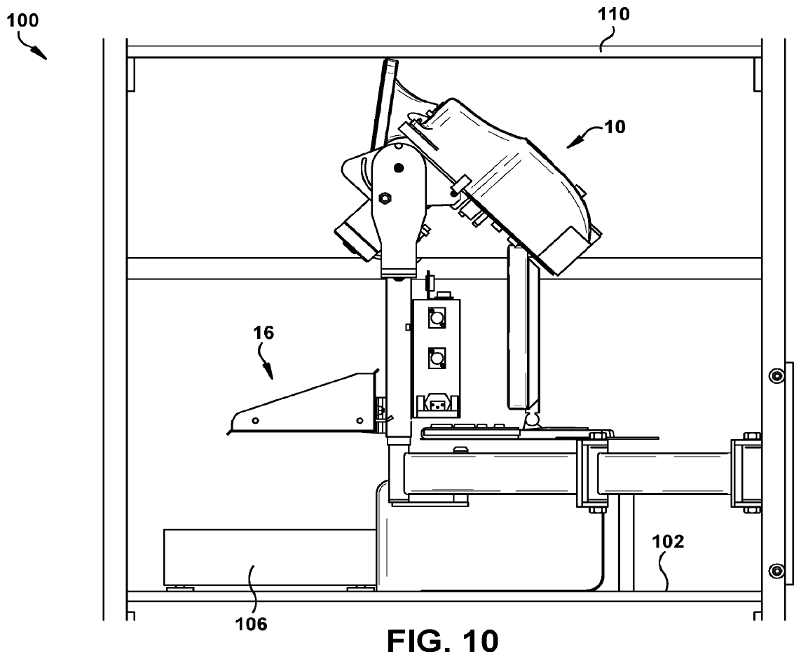

The converter 10 also has a housing 26 (partially removed in FIG. 3) that encloses at least a portion of the conversion assembly 14. The housing 26 may be supported by a stand 30 to deliver dunnage products to a location above a packing surface, such as a table, and more particularly directly into a container resting atop the table or other horizontal packing surface (such as is shown in FIGS. 7-10). The stand 30 typically supports both the converter 10 and the supply 16 of sheet stock material 12, both of which preferably are rotatable together about a vertical axis 32 to facilitate access to the stock supply 16 for renewing the sheet stock material 12 in the supply 16 and to facilitate directing the dunnage products to the desired location during use. The stand 30 also may allow the operator to rotate the converter 10 about a horizontal axis 34 to change the angle at which the dunnage product exists the converter 10 relative to the packing surface.

The supply 16 of stock material 12 may take the form of a tray or shelf mounted to the stand 30 or the converter housing 26 for rotation with the converter 10 about the vertical axis 32 such that the relative orientation of the converter 10 and the stock supply 16 about the vertical axis 32 remains constant. As a result, the orientation of the converter 10 about the vertical axis 32 can be changed without having to separately orient the stock supply 16 relative to the converter 10.

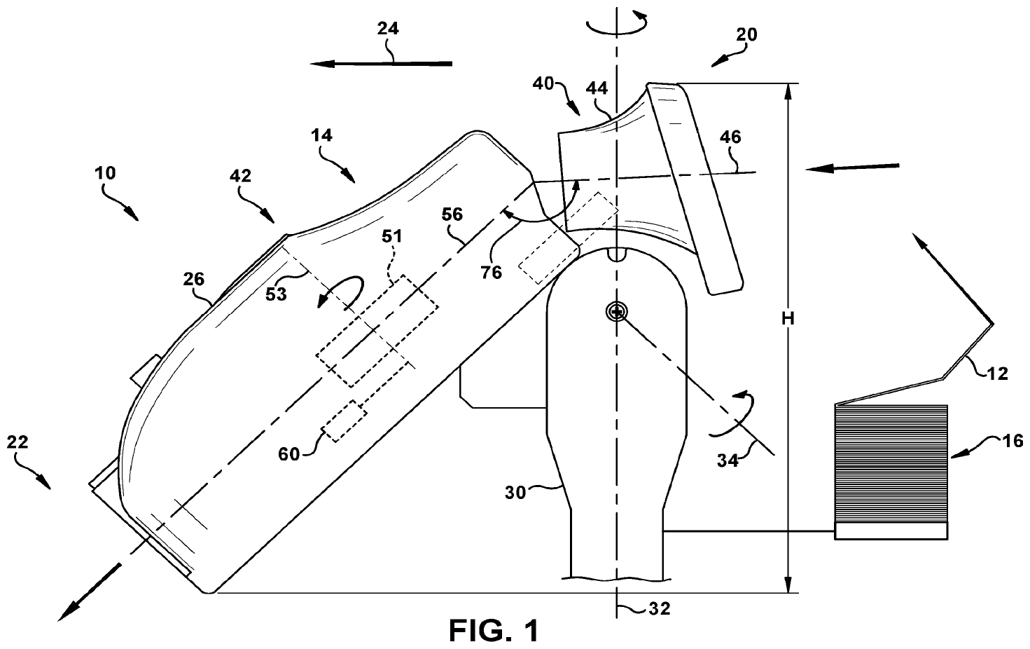

The stock supply assembly 16 supplies one or more plies of sheet stock material 12 to the converter 10, specifically the conversion assembly 14 described below. The stock supply assembly 16 may supply the sheet stock material 12 in the form of a roll, rotatable about a central axis as the sheet material is payed out, or in the form of a fan-folded stack, as shown in FIG. 1. The sheet stock material 12 typically consists of paper, specifically kraft paper, and preferably about fifteen inch (about thirty-eight centimeters) wide kraft paper. A paper dunnage product is an environmentally responsible protective packaging material; paper is recyclable, reusable, and composed of a renewable resource. Other sheet materials can be suitable alternatives to paper, however, in appropriate applications.

The converter 10 may include a constant-entry guide mounted between the stock supply 16 and the conversion assembly 14 to guide the sheet stock material 12 from the supply 16 to the conversion assembly 14 from a constant location as the stock material 12 in the supply 16 is drawn down. Provision may be made for the constant-entry guide to be moved out of the way to facilitate loading sheet stock material 12 into the conversion assembly 14 and to be replaced in the operating position prior to operating the converter 10 to produce dunnage products.

The conversion assembly 14 includes a forming assembly 40 downstream of the stock supply 16, and a feeding assembly 42 downstream of the forming assembly 40. The feeding assembly 42 pulls the stock material 12 from the supply 16 and through the forming assembly 40. The forming assembly 40 inwardly gathers and randomly crumples the stock material 12 into a desired relatively lower-density state than the original supply 16 of sheet stock material 12. Different types of forming assembly may be employed to create different cross-sectional shapes, such as those better suited for use as a void-fill dunnage product or as a cushioning dunnage product, for example.

An exemplary forming assembly 40 includes a gathering chute 44 that converges along a converging axis 46 in the downstream direction 24 from a relatively larger inlet to a relatively smaller outlet. In other words, the gathering chute 44 may have a funnel shape that inwardly gathers and randomly crumples the stock material 12 as the stock material 12 is drawn through the gathering chute 44. Converging surfaces inside the gathering chute 44 define a progressively smaller cross-sectional area within which the stock material 12 is inwardly drawn and gathered, randomly crumpling as it moves downstream to form a strip of dunnage. The gathering chute 44 may have a round or oval cross-sectional shape, which may change along its length, and the converging surfaces that form the gathering chute 44 generally provide a smooth transition for the stock material 12 to inwardly gather and crumple without tearing. The gathering chute 44 defines a path for the sheet stock material 12 through the forming assembly 40, and may partially or completely bound the path along the converging axis 46 toward the feeding assembly 42.

The feeding assembly 42 includes a pair of opposed rotating members 50 and 51, alternatively referred to as rotatable members 50 and 51, that rotate a about respective axes 52 and 53 in parallel planes to define a path through the feeding assembly 42 along a feed axis 56 that passes between the rotating members 50 and 51 perpendicular to a plane containing both of the axes of rotation 52 and 53. Suitable rotatable members 50 and 51 include wheels or friction rollers capable of engaging the sheet stock material 12 to move it through the conversion machine 10. The rotating members 50 and 51 also may crimp, crease, or connect the crumpled sheet stock material as the strip of dunnage shaped by the forming assembly 40 passes between the rotating members 50 and 51 to help the strip of dunnage retain its shape.

An operator controls operation of the feeding assembly 42 via a controller 60, which can be located remotely or mounted to the housing 26. Typically the controller 60 includes a processor and a memory, and one or more input and output devices, such as a touch-screen, a foot switch, and one or more discrete nobs or buttons. Accordingly, the rotating members 50 and 51 may be driven by a motor, such as an electric motor, along with corresponding gears in a gear train to provide the desired speed, and the motor may be controlled by the controller 60 to control the speed and operation of the rotating members 50 and 51.

The feeding assembly 42 may further include guides on one or more sides of the path of the sheet stock material 12 through the feeding assembly 42. In the illustrated embodiment, a pair of laterally-spaced guides 70 extend from a mounting location 72 upstream of respective ones of each of the rotating members 50 and 51 to a downstream location 74 downstream of the axes of rotation 52 and 53 of the rotating members 50 and 51, thereby providing a continuous guide surface past each of the rotating members 50 and 51. The guides 70 typically also extend beyond the maximum diameter of the rotating members 50 and 51, i.e., to a position not just past the axes of rotation 52 and 53 but past the downstream-most extent of the rotating members 50 and 51. This continuous guide surface 70 helps to prevent or eliminate jamming problems that may occur if the sheet material was able to wrap itself around either of the rotating members 50 and 51, guiding the formed strip of dunnage safely past the rotating members 50 and 51 to a location removed from contact with the rotating members 50 and 51 without significantly impeding the progress of the strip of dunnage through the feeding assembly 42. The downstream end of one or both of the guides 70 may be free or may be secured at a downstream location 74 downstream of the rotating members 50 and 51, as shown. The guides 70 may be formed of nylon, other plastic, or metal, such as stainless steel, and may be flexible or rigid.

Alternatively, the feeding assembly 42 may include guides that bound a path of the sheet stock material 12 from the forming assembly 40 to a position downstream of the feeding assembly 42. In such an arrangement, the rotatable members 50 and 51 may extend through opposing openings in the guides to engage the sheet stock material 12 therebetween. The guides also may converge from a relatively large upstream opening adjacent the outlet of the converging chute 44 to a narrower opening adjacent the rotatable members 50 and 51.

The conversion assembly 14 optionally may further include a severing mechanism 74 downstream of the feeding assembly 42 for severing discrete lengths of dunnage products from the formed strip. The dunnage products exit the conversion machine 10 at the outlet at the downstream end 22 of the converter 10 for use as packing material.

In previous dunnage conversion machines, the converging axis and the feed axis generally are axially aligned. This may have been believed to have been necessary to prevent or minimize tearing of the sheet material during the forming and feeding operations. Tearing was a significant concern in some conversion machines and numerous efforts were undertaken to minimize or eliminate tearing as the stock material is drawn from the supply through the conversion machine.

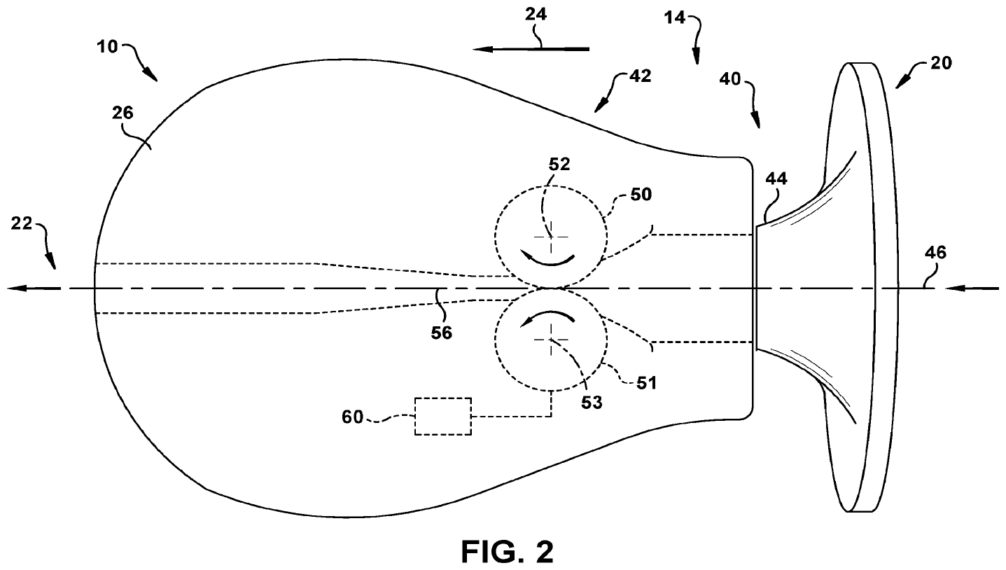

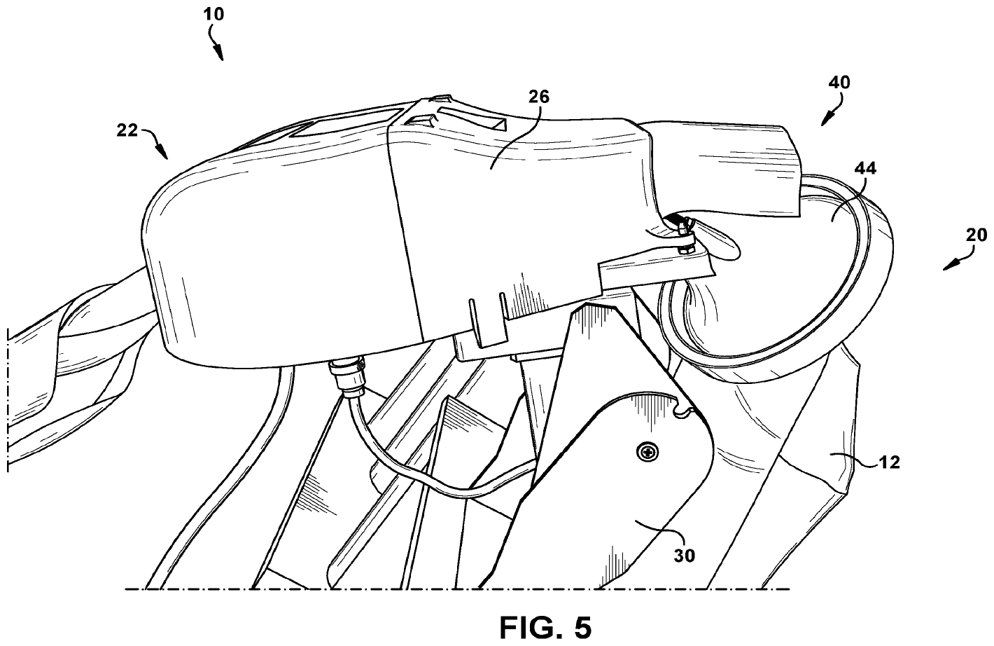

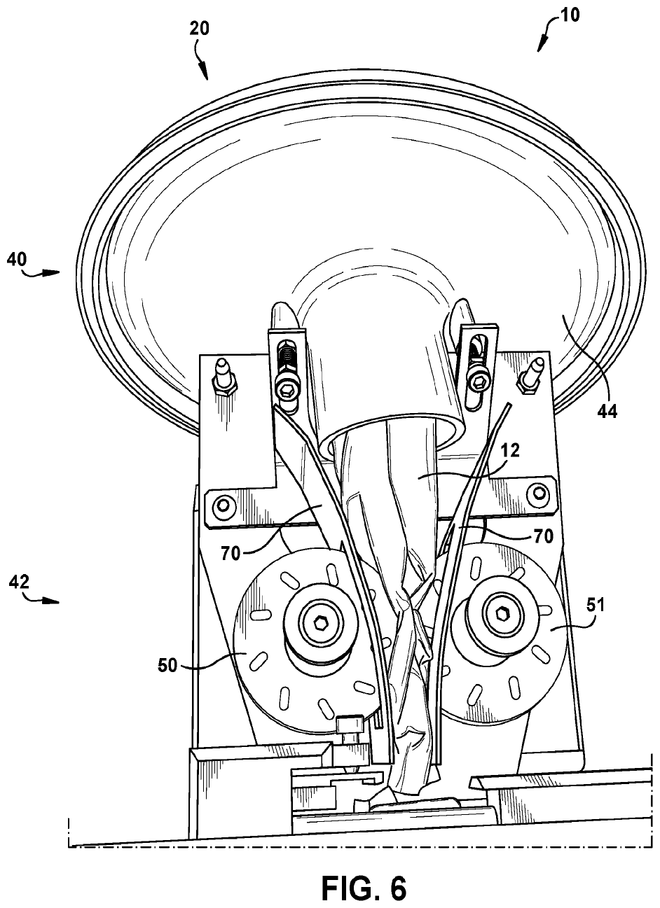

The present converter 10 also provides a more compact volume than previous converters, particularly a volume with a reduced height dimension H. FIGS. 7 to 10 illustrate one application of a packaging station 100 for use in locations with a limited available height. In this configuration, the converter 10 is required to be mounted within a shelving area with a height restriction (from a table top packaging surface 102 to an elevated shelf or other vertically-displaced obstruction above the packaging surface 102). With previous converters, this vertical space limitation has been problematic. Open packaging containers, such as the illustrated cardboard box 104, typically would be supported on the packaging surface 102, such as the table top as shown, which may further include a weigh scale 106 on the table top 102 that further reduces the available vertical space for the converter 10 to dispense packaging material into the container 104. For example, if an open packaging container 104 that is thirty inches (76 cm) tall is placed on a four inch (10 cm) high weigh scale 106, in a four foot (122 cm) high space between the table top packing surface 102 and an elevated shelf 110 the converter 10 would have only fourteen inches (35.5 cm) of height available to deliver dunnage directly into the container 104. This may not be sufficient for previous converters to dispense dunnage directly into the container, and there may not be sufficient space for the converter to be re-oriented to accommodate boxes with varying heights or to access to the converter 10 or to load sheet stock material into the supply 16, etc. But the converter 10 shown in FIGS. 1-10 provides an exemplary solution to that problem.

To reduce the height of the converter 10 when operating within a desired variation of orientation and within vertical space limitations, the inventors arranged the converging axis 46 of the converging chute 44 to be transverse the feed axis 56 of the feeding assembly 42. More specifically, the converging axis 46 and the feed axis 56 are not aligned axially, but define an internal angle 76 therebetween, such as about ten to about eighty degrees, about twenty to about ninety degrees, about thirty to about seventy degrees, about forty to about sixty degrees, or about forty-five degrees. This internal angle 76 may be fixed.

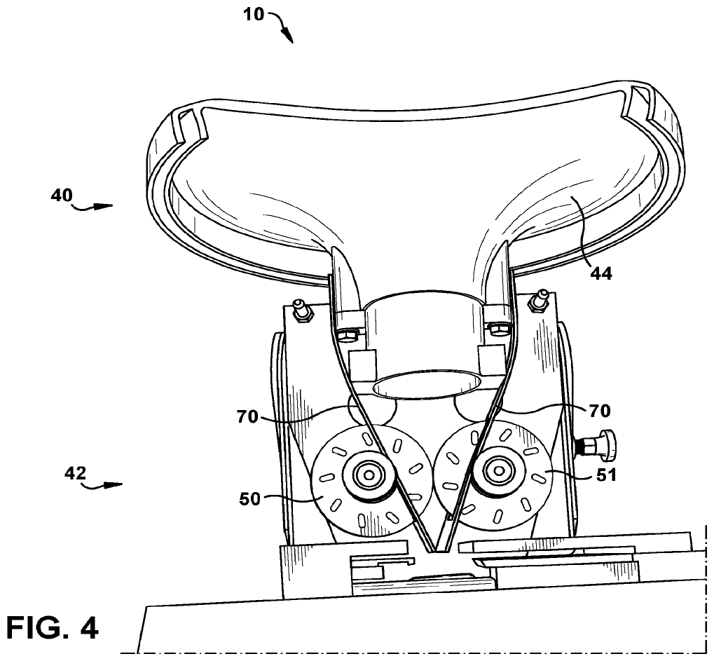

According to a further modification, a top portion of an upstream end of the converging chute 44 may be removed, omitted, cut, flattened, or otherwise reduced to further reduce the overall height of the converter 10, as seen in FIG. 4. In other words, the converging chute 44 may have a top side, opposite the internal angle 76 between the converging axis 46 and the feed axis 56, and the top side of the converging chute 44 may be truncated to less than a fully round shape.

Although not shown, a further modification may include removing the converging chute 44 from the feeding assembly 44 such that the converging axis 46 extends upward above a supply 16 of sheet stock material 12, and then guiding the inwardly-gathered strip of sheet material from the downstream end of the converging chute 44 to the feeding assembly 42 using a guide member, such as a roller, to turn the inwardly-gathered sheet material from the converging axis 46 to the feed axis 56.

The present invention also provides a dunnage conversion system that includes the dunnage conversion machine 10 just described and a supply 16 of sheet stock material 12 upstream of the forming assembly 40 that is arranged to supply sheet stock material 12 to the forming assembly 40.

Accordingly, the present invention provides a dunnage conversion machine 10 for converting a sheet stock material 12 into a relatively lower density dunnage product as the sheet stock material 12 moves downstream through the dunnage conversion machine 10. The dunnage conversion machine 10 includes a forming assembly 40 configured to inwardly gather sheet stock material 12, and a feeding assembly 42 downstream of the forming assembly 40. The forming assembly 40 includes a converging chute 44 with an inlet and a relatively smaller outlet downstream of the inlet, the converging chute 44 being aligned along a converging axis 46. The feeding assembly 42 has a pair of rotatable members 50 and 51 rotatable about respective parallel axes of rotation 52 and 53. The rotatable members 50 and 51 are arranged to feed sheet stock material 12 from the forming assembly 40 downstream of the feeding assembly 42, and the rotating members 50 and 51 define a feed axis 56 perpendicular to the axes of rotation 52 and 53 and to a line connecting and perpendicular to each of the axes of rotation 52 and 53. The converging axis 46 is transverse the feed axis 56 and the converging axis 46 and the feed axis 56 define an internal angle 76 therebetween of between ten and eighty degrees.

Although the invention has been shown and described with respect to a certain preferred embodiment, it is obvious that equivalent alterations and modifications will occur to others skilled in the art upon the reading and understanding of this specification and the annexed drawings. In particular regard to the various functions performed by the above described components, the terms (including a reference to a “means”) used to describe such components are intended to correspond, unless otherwise indicated, to any component which performs the specified function of the described component (i.e., that is functionally equivalent), even though not structurally equivalent to the disclosed structure which performs the function in the herein illustrated exemplary embodiments of the invention. In addition, while a particular feature of the invention can have been disclosed with respect to only one of the several embodiments, such feature can be combined with one or more other features of the other embodiments as may be desired and advantageous for any given or particular application.

1. A dunnage conversion machine for converting a sheet stock material into a relatively lower density dunnage product as the sheet stock material moves downstream through the dunnage conversion machine, the dunnage conversion machine comprising:
a forming assembly including a converging chute with an inlet and a relatively smaller outlet downstream of the inlet, the converging chute being aligned along a converging axis;
a feeding assembly having a pair of rotatable members rotatable about respective parallel axes of rotation, the rotatable members being arranged to feed sheet stock material from the forming assembly, the rotating members defining a feed axis perpendicular to a line connecting and perpendicular to the axes of rotation;
a stand supporting both the forming assembly and the feeding assembly; and
a stock material supply mounted to the stand;
wherein the converging axis is transverse the feed axis;
wherein the feeding assembly includes a pair of laterally-spaced guides that bound a path of the sheet stock material that narrows from an opening adjacent to the forming assembly to an outlet downstream of the rotatable members;
wherein the stand is rotatable about a vertical axis such that the forming assembly, the feeding assembly, and the stock material supply rotate with the stand about the vertical axis; and
wherein the stand has a horizontal axis that intersects the vertical axis, and the forming assembly and the feeding assembly are rotatable about the horizontal axis relative to the stand.

2. The dunnage conversion machine as set forth in claim 1, wherein an internal angle between the feed axis and the converging axis is between 20 degrees and 90 degrees.

3. The dunnage conversion machine as set forth in claim 2, wherein the internal angle is between 30 degrees and 70 degrees.

4. The dunnage conversion machine as set forth in claim 2, wherein the internal angle is between 40 degrees and 60 degrees.

5. The dunnage conversion machine as set forth in claim 2, wherein the internal angle is fixed.

6. (canceled)

7. The dunnage conversion machine as set forth in claim 1, wherein the rotatable members extend beyond the pair of laterally-spaced guides to engage sheet stock material between the rotatable members.

8. (canceled)

9. The dunnage conversion machine as set forth in claim 1, wherein the rotatable members include friction wheels.

10. The dunnage conversion machine as set forth in claim 1, wherein the converging chute has a top side, opposite the internal angle between the converging axis and the feed axis, the converging chute has a round cross-section, and the top side of the converging chute is truncated to less than a fully round shape.

11. The dunnage conversion machine as set forth in claim 1, wherein the converging chute converges in a downstream direction.

12. The dunnage conversion machine as set forth in claim 1, wherein the forming assembly is configured to inwardly gather sheet stock material.

13. The dunnage conversion machine as set forth in claim 1, wherein the feeding assembly is downstream of the forming assembly.

14. (canceled)

15. The dunnage conversion machine as set forth in claim 1, wherein the pair of laterally-spaced guides extend from respective mounting locations located upstream of the rotating members to a location downstream of the rotating members.

16. The dunnage conversion machine as set forth in claim 1, wherein the pair of laterally-spaced guides extend from respective mounting locations located upstream of the rotating members to a location downstream of the rotating members. and are secured to respective mounting locations downstream of the rotating members.

17. The dunnage conversion machine as set forth in claim 1, wherein the pair of laterally-spaced guides are formed of a material selected from nylon and stainless steel.

18. The dunnage conversion machine as set forth in claim 1, wherein the pair of laterally-spaced guides are flexible.

19. The dunnage conversion machine as set forth in claim 1, wherein the pair of laterally-spaced guides are rigid.

20. The dunnage conversion machine as set forth in claim 1, wherein the stock material supply is selected from a tray and a shelf.
